(19) United States
(12) Patent Application Publication
(10) Pub. No.: US 2010/0149943 A1
(43) Pub. Date: Jun. 17, 2010

(54) OPTICAL DISC AND OPTICAL DISC DEVICE

(75) Inventors: Kazuo Kuroda, Saitama (JP); Eiji Muramatsu, Tsurugashima-shi (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/530,445

(22) PCT Filed: Mar. 7, 2007
(86) PCT No.: PCT/JP2007/054440

§ 371 Date: Sep. 30, 2009

(51) Int. Cl. G11B 7/00; B32B 3/02

(52) U.S. Cl. 369/100; 428/64.4; G9B/7

(57) ABSTRACT

Provided herein is an optical disc having: an optical plotting layer which is formed at a label surface side and on which an image is formed by heat change with a laser beam emitted from a recording surface side; a protective layer which is formed at the label surface side of the optical plotting layer, protects the optical plotting layer, and through which the image can be viewed from the label surface side; a reflective layer which is formed at the recording surface side of the optical plotting layer and reflects the laser beam; and a substrate which supports the reflective layer, the protective layer and the optical plotting layer.

### TECHNICAL FIELD

The present invention relates to an optical disc having an optical plotting layer at a label surface side on which an image can be plotted with a laser beam from a recording surface side and an optical disc apparatus.

### BACKGROUND ART

A known optical disc which can be plotted on a label surface thereof with a laser beam has, from a recording surface side, the first substrate, an information recording layer, a reflective layer, an adhesive layer, the second substrate, an image recording layer and a protective layer in layers (for example, Patent Document 1). In this case, a visible image which is visible from the label surface side is plotted on the image recording layer with a CD (Compact Disc) laser beam, while the information recording layer is tracked by a DVD (Digital Versatile Disc) laser beam. Further, the reflective layer is made up of a wavelength selectivity transmitting reflective film and is capable of transmitting the CD laser beam.

### [Patent Document 1] JP-A-2005-196917

### DISCLOSURE OF THE INVENTION

### Problems to be Solved

In such a known optical disc, as the image recording layer is plotted while the information recording layer is tracked, the tracking laser beam needs to be focused on the information recording layer. In this case, if the information recording layer and a plotting layer are apart from each other, there is a possibility that the laser beam focused on the information recording layer could be defocused on the plotting layer. The information recording layer and the plotting layer must be close enough to be focused by which sufficient heat quantity can be obtained with the laser beam emitted on the plotting layer, even in a state that the laser beam is focused on the information recording layer. But, if an information recording apparatus is close to the plotting layer, heat generated when information is recorded on the information recording layer could be transmitted to the plotting layer, leading to a possibility to overwrite an image and the like already plotted by impacting pigments in the plotting layer.

Further, a track pitch of the DVD is 0.74 μm and a track pitch of the CD is 1.6 μm. When the optical disc is tracked at the DVD track pitch and is plotted with the CD beam, an image is overwritten and a power control may be complex and difficult with a defocused beam. Despite that there is a CD broad beam, if the optical disc is tracked with the DVD laser beam, it comes up with a disadvantage of time-consuming because of the overwrite.

There is an advantage of the invention is to provide an optical disc on which an image having sufficient contrast when viewed from the label surface side can be plotted with a laser beam from a recording surface side and in which a plotting layer and an information recording layer are configured to be properly apart from each other, and an optical disc apparatus.

### Means to Solve the Problems

The invention provides an optical disc includes: an optical plotting layer which is formed at a label surface side and on which an image is formed by heat change with a CD laser beam emitted from a recording surface side; a protective layer which is formed at the label surface side of the optical plotting layer, protects the optical plotting layer, and through which the image can be viewed from the label surface side; a reflective layer which is formed at the recording surface side of the optical plotting layer and reflects the CD laser beam; a substrate which supports the reflective layer, the protective layer and the optical plotting layer; a bonded substrate laminated at the recording surface side of the substrate; and an information recording layer formed at a bonded side of the bonded substrate and on which information is recorded and/or reproduced with a DVD laser beam. The information recording layer has a wavelength selectivity transmitting reflective film which reflects the DVD laser beam and transmits the CD laser beam.

According to the configuration, as the reflective layer is provided at the recording surface side of the optical plotting layer, the image plotted on the optical plotting layer can have sufficient contrast, regardless of a ground color thereof. Further, even if the optical plotting layer is configured with material having low light absorption, it is possible to change the optical plotting layer by heat properly by heating the reflective layer with an optical spot and transferring the heat to the optical plotting layer (a heat transfer between solid substances). It is preferable that leuco dye/long-chain type developer, cholesteric liquid crystal (a color) and the like be used as heat sensitive material of the optical plotting layer.

Further, even if the optical plotting layer and the information recording layer are formed in stack, it is possible to plot on the optical plotting layer adequately by using a laser beam of which wavelength is different from that used for recording on/producing from the information recording layer.

In this case, it is preferable that the optical plotting layer have a guide track.

According to the configuration, it is possible not only to plot accurately by using the guide track for tracking and focusing for plotting, but also to plot clearly without a line blooding (blurring) or the like by changing the heat sensitive material in the guide track by heat.

In this case, it is preferable that the reflective layer, the protective layer and the optical plotting layer be formed in an area other than a data area.

According to the configuration, as the information recording layer and the like for recording/reproduction and the optical plotting layer are not stacked, it is possible to plot on the optical plotting layer without giving any effect on the information recording layer (and the reflective layer) and the like.

In this case, it is preferable that the optical plotting layer be made up of heat sensitive material mixed with a metallic particle.

According to this configuration, as the heat is transferred from the reflective layer to the optical plotting layer smoothly, it is possible to promote the heat change of the optical plotting layer.

In this case, it is preferable that the protective layer serve as a printing layer capable of being printed by a printing apparatus.

In this configuration, it is possible to plot on the optical plotting layer by the beam and to plot on the protective layer by the printing apparatus. Therefore, a user can select which plotting type may be used. Accordingly, it is possible to enhance flexibility of the plotting type which is viewable from the label surface side.

Likewise, it is preferable that the protective layer serve as a printing layer capable of being printed by the printing apparatus, and color of non-plotted optical plotting layer be tinged with white.

According to the configuration, as the optical plotting layer to be ground color is tinged with white, even if the printing apparatus prints on the protective layer, it is possible to obtain a plotting result having sufficient contrast against a plotting result printed on the protective layer.

The invention provides an optical disc apparatus that is introduced with the optical disc described above, emits a DVD laser beam on an information recording layer to record and/or reproduce information, and emits a CD laser beam on an optical plotting layer to plot an image.

According to the configuration, it is possible to form an arbitrary image on the optical disc viewable from the label surface side by using a recording/reproducing laser beam, a drive system and a control system for the optical disc.

### BRIEF DESCRIPTION OF THE DRAWINGS

FIG. 1 is a block diagram of an optical disc apparatus according to an embodiment.

FIG. 2 is a diagramic sectional view of an optical disc (a DVD-R) of the embodiment.

FIG. 3 is a partially enlarged perspective view around a plotting guide track.

FIG. 4 is an enlarged sectional view around the plotting guide track.

FIG. 5 is a diagramic sectional view of an optical disc (a DVD-R) according to a modified example of the first embodiment.

FIG. 6 is a partially enlarged perspective view around a plotting guide track according to the modified example of the first embodiment.

FIG. 7 is a diagramic sectional view of an optical disc (a Blu-ray Disc) according to the second embodiment.

FIG. 8 is a diagramic sectional view of an optical disc (a DVD-R) of the third embodiment.

### REFERENCE NUMERALS

1 optical disc apparatus 2 optical pickup 11 first substrate 12 information recording layer 13 first reflective layer 15 second substrate 16 second reflective layer 17 optical plotting layer 18 protective layer 24 plotting guide track 25 image forming layer 27 DVD laser beam 28 CD laser beam 31 concave portion 32 flat portion 33 land 41 information recording layer 42 first reflective layer 43 substrate 44 second reflective layer 45 optical plotting layer 46 protective layer 54 plotting guide track 57 Blu-ray Disc laser beam 61 data area 62 clamp area A recording surface B label surface D, Da, Db, Dc optical disc

### BEST MODES FOR CARRYING OUT THE INVENTION

An optical disc and an optical disc apparatus of the invention will be explained hereinbelow with reference to accompanying drawings. The optical disc is configured with, for example, a DVD-R or a Blu-ray Disc, and has an information recording layer on which information is recorded/reproduced and an optical plotting layer on which a title name of the recorded information or a notation such as “DVD-ROM” after finalization is plotted to be viewed. The optical disc apparatus has a function for recording/reproducing on a CD or a DVD (a Blu-ray Disc) and is configured to be able to plot a predetermined image on an optical plotting layer of the optical disc by using the function.

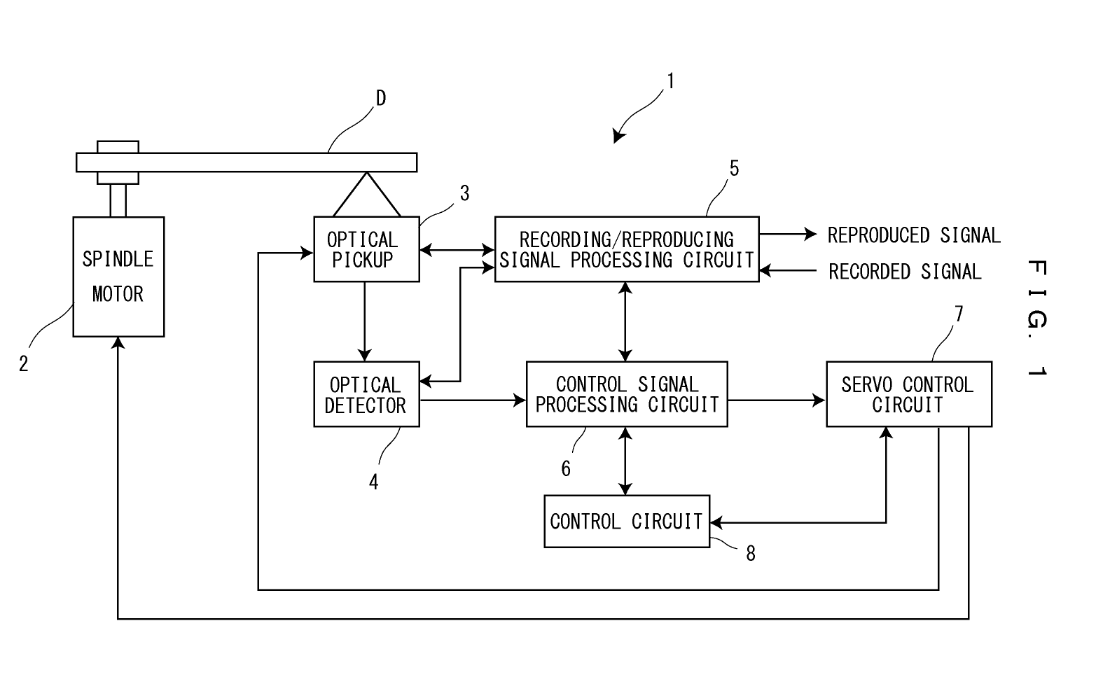

As shown in FIG. 1, the optical disc apparatus 1 has: a spindle motor 2 which rotates an optical disc D; an optical pickup 3 which emits a laser beam on the optical disc D; an optical detector 4 which detects a reflective light from the optical disc D; a recording/reproducing signal circuit 5 which controls the laser beam; a control signal processing circuit 6 which generates a control signal such as a tracking error signal or a focus error signal based on a detected result of the optical detector 4; a servo control circuit 7 which controls the optical pickup 3 based on the control signal generated by the control signal processing circuit 6; and an integral control circuit 8 which integrally controls overall.

The spindle motor 2 rotates the optical disc D at a constant angular velocity (CAV method) or at a constant linear velocity (CLV method). The optical pickup 3 emits the laser beam functioning as a recording beam or a reproducing beam from a recording surface side of the optical disc D and transmits the reflective light from the recording surface side to the optical detector 4. In this case, the optical pickup 3 includes, for example, a CD semi-conductor laser (the wavelength thereof is 780 nm), a DVD semi-conductor laser (the wavelength thereof is 650 nm) and a Blue-ray Disc semi-conductor laser (the wavelength thereof is 405 nm). The optical pickup 3 has an optical system including an objective lens, a focus actuator, a track actuator, a light-sensitive element (the optical detector 4), a position sensor and the like (not shown).

The optical detector 4 converts the reflective light received from the optical pickup 3 to an electrical signal (a detected signal) and outputs it to the recording/reproducing signal circuit 5 and the control signal processing circuit 6. The recording/reproducing signal circuit 5 receives a recording signal at the time of recording on the optical disc D and outputs it to the optical pickup 3 after an encoding process and a modulation process are processed thereon. At the time of reproducing on the optical disc D, the recording/reproducing signal circuit 5 gives an encoding process and a D/A conversion process and the like on the detected signal input from the optical detector 4 and outputs it as an reproduction signal to a video image output unit and an audio output unit (not shown).

The control signal processing circuit 6 receives the detected signal from the optical detector 4, generates a control signal for tracking servo, focus servo and the like, and outputs it to the servo control circuit 7 and the integral control circuit 8. The servo control circuit 7 generates a drive control signal for controlling the spindle motor 2 and the optical pickup 3 based on the tracking error signal, the focus error signal and the like input from the control signal processing circuit 6, and outputs it to the spindle motor 2 and the optical pickup 3. The integral control circuit 8 has a CPU and controls respective component units comprehensively based on a prepared program.

When the optical disc D is recorded, the optical disc D is tracked based on the tracking error signal generated from the detected signal of the optical detector 4 and a mark is formed on the information recording layer 12 with a strong laser power beam (a recording beam) for recording. Further, when the optical disc D is reproduced, a weak laser power beam (a reproducing beam) is emitted on the optical disc D, the reflective light thereof is detected by the optical detector 4, and the recorded information is read out based on the detected signal for reproduction.

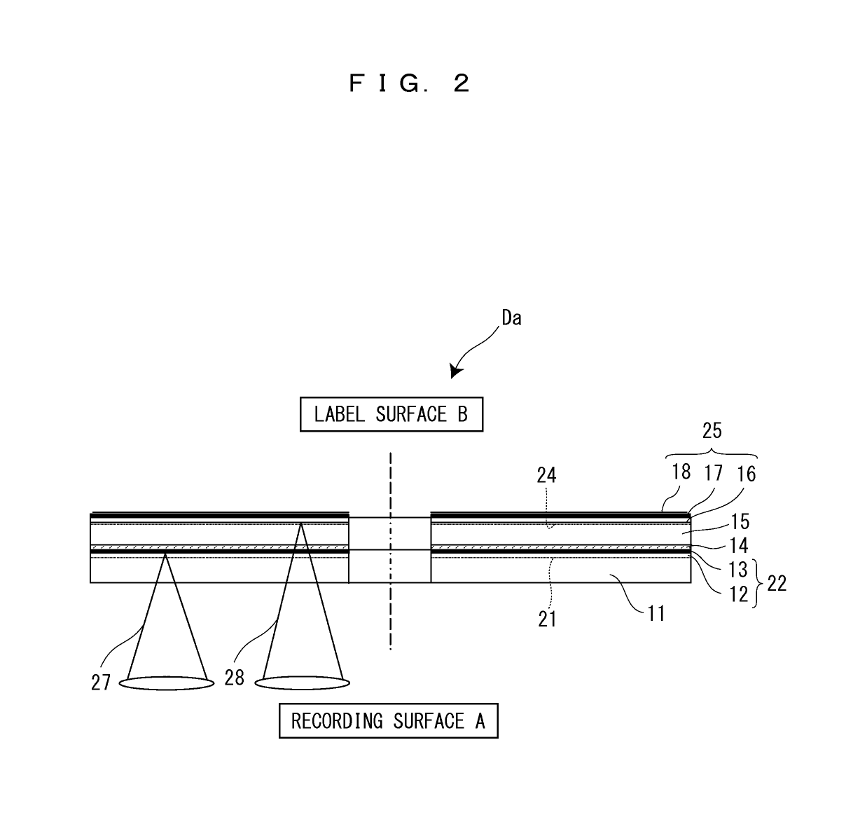

As shown in FIG. 2, an optical disc Da made up of a DVD-R has, from a recording surface A-side, the first substrate (a bonded substrate) 11, an information recording layer 12, the first reflective layer 13, an adhesive layer 14, the second substrate (a substrate) 15, the second reflective layer 16, an optical plotting layer 17 and a protective layer 18 in layers. It is preferable that the second substrate (the substrate) 15 have a thickness by which heat generated at the time of recording information on the information recording layer 12 does not affect the optical plotting layer 17. A recording/reproducing guide track 21 is formed on the information recording layer 12, and a DVD layer 22 for recording/reproducing with a DVD semi-conductor laser is formed with the information recording layer 12 and the first reflective layer 13. Likewise, a plotting guide track 24 is formed on the optical plotting layer 17, and an image forming layer 25 for plotting with a CD semi-conductor laser is made up of the second reflective layer 16, the optical plotting layer 17 and the protective layer 18. Note that the DVD layer 22 may have two layers (multiple layers).

The first substrate 11 is made up of polycarbonate or the like. The information recording layer 12 is made up of organic coloring material and when a DVD laser beam 27 is emitted, it is metamorphosed and a so-called pit is formed thereon. The DVD laser beam 27 (650 nm) emitted from the optical pickup 3 tracks on the recording/reproducing guide track 21. The first reflective layer 13 is configured of a metallic film or the like constituted by a wavelength selectivity transmitting reflective film. The reflective layer 13 reflects the DVD laser beam 27 transmitted through the first substrate 11 and the information recording layer 12 while transmitting a CD laser beam 28 (780 nm).

Likewise, the second substrate 15 is made up of polycarbonate or the like. The second reflective layer 15 is made up of a metallic film such as gold, silver or aluminum. The second reflective layer 15 reflects the CD laser beam 28 transmitted through the first substrate 11, the information recording layer 12, the first reflective layer 13, the adhesive layer 14 and the second substrate 15 while reflecting a visible light transmitted through the protective layer 18 and the optical plotting layer 17 from a label surface B-side. The optical plotting layer 17 is configured to form an image thereon by heat sensitive change (heat discoloration) with the CD laser beam 28 from the recording surface A-side, and is made up of heat sensitive material such as, for example, leuco dye/long-chain type developer and cholesteric liquid crystal (a color image). In this case, it is preferable that metallic particles be mixed with the heat sensitive material so as to enhance heat absorbability (optical absorbability). The CD laser beam 28 emitted from the optical pickup 3 tracks on the plotting guide track 24.

The protective layer 18 protects the optical plotting layer 17 and is made up of transparent or translucent protective material. The protective layer 18 is so configured that the image formed on the optical plotting layer 17 can be viewed from the label surface B-side. The protective layer 18 also serves as a printing layer having ink retentive force and the surface thereof may be printed by a dedicated printer (a printing apparatus). In other words, the optical disc Ca in the embodiment is so configured that the CD laser beam 28 can plot on the optical plotting layer 17 from the recording surface A-side and the printer (for example, an ink jet printer) can plot on the protective layer 18 from the label surface B-side. It is preferable that color of the optical plotting layer 17 be tinged with white so as to enhance visibility of a plotted result by the printer. The CD laser beam 28 plots, needless to say, so-called mirror letters and the printer plots normal image letters.

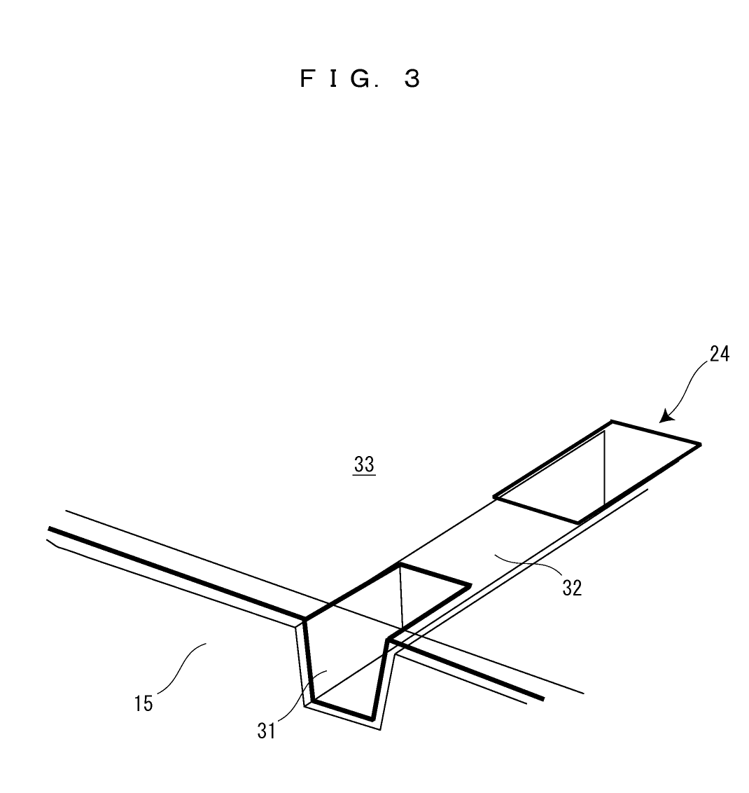

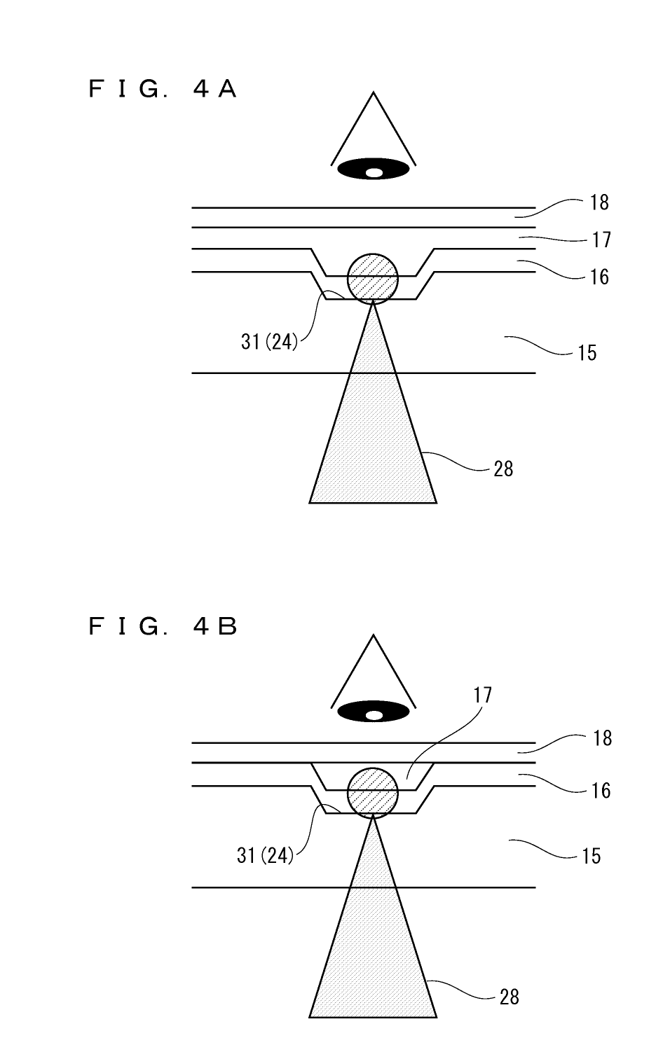

As shown in FIGS. 3, 4A and 4B, the plotting guide track 24 is formed in a guide direction (an extended direction) intermittently, that is, concave portions 31 and flat portions 32 are formed alternatively and successively in the guide direction. The surface of the second substrate 15 is made up of numerous concave portions 31, numerous flat portions 32 and a land 33. The film-like second reflective layer 16 is formed thereon. As shown in FIG. 4A, the heat sensitive material of the optical plotting layer 17 may be formed only on the numerous concave portions 31, and as shown in FIG. 4B, it may be formed on the numerous concave portions 31, the numerous flat portions 32 and the land 33.

The plotting operation is performed with the CD laser beam 28 emitted on a desired position of the optical plotting layer 17 (the second reflective layer 16) based on plotting data while the CD laser beam 28 tracks on the plotting guide track 24. Specifically, the CD laser beam 28 is transmitted through the first substrate 11, the information recording layer 12 and the first reflective layer 13, and the reflective light of the CD laser beam 28 emitted on the plotting guide track 24 is detected by the above optical detector 4. Then, the control signal processing circuit 6 generates a tracking servo control signal based on the detected signal. The servo control circuit 7 moves the objective lens for tracking by a lens actuator (not shown) based on the tracking error signal. Thus, the CD laser beam 28 can accurately track on the plotting guide track 24 and can plot at a desired position by changing the laser power. The CD laser beam 28 on the optical plotting layer 17 is emitted with laser power which makes the heat sensitive material change in color at a desired position on the optical disc based on a control table which sets a relationship between strength/weakness of the laser power of the CD laser beam 28 and the change in color of the heat sensitive material. The position on the optical plotting layer 17 to be emitted with the laser based on the plotting data can be determined, for example, based on address information or the like preliminary provided in a pre-bit on the plotting guide track 24. Accordingly, the optical disc Da is plotted by heat discoloration of heated portions on the optical plotting layer 17 with optical spots of the CD laser beam 28. More specifically, the CD laser beam 28 is spotted on the second reflective layer 16, leading to heat the second reflective layer 16. The heated portions of the optical plotting layer 17 transferred with heat from the second reflective layer 16 change in color by the heat.

In the structure shown in FIG. 4A, as the heat sensitive material of the optical plotting layer 17 in each of the concave portions 31 changes in color by heat, the numerous concave portions 31 can function as pixels in an image. Therefore, though contrast (density) degrades to a certain degree, it is possible to plot clearly without line bleeding (blurring) and the like. On the other hand, in the structure shown in FIG. 4B, as the heat sensitive material of the optical plotting layer 17 on the flat portions 32 and the land 33 in addition to each concave portion 31 changes in color by heat, an image having sufficient contrast can be obtained. Further, by forming heat sensitive material which produces different color in each of the concave portions 31, it is possible to plot with multiple colors. A similar effect can be obtained by forming heat sensitive material which can produce different color by a track unit or a predetermined address.

Further, it is possible to obtain an address signal of the optical plotting layer 17 by the concave portions 31 and the flat portions 32, besides the tracking signal by the plotting guide track 24. Therefore, when the optical plotting layer 17 is plotted with the CD laser beam 28 and the image data is, for example, a bitmap type, the image data is converted to polar coordinates data, a plotting position may be defined based on a relationship between an actual position on the surface of the optical disc and a position instructed by an address of the optical plotting layer 17. When plotting, if positions of letters “DVD-R” pre-protted on the optical disc Da can be recognized (or the letters “DVD-R” are plotted at known positions), it is possible to alter a notation from “DVD-R” of the optical disc after finalization to “DVD-ROM” by plotting “OM” thereafter. Accordingly, it is possible to display such as DVD ROM disc after recording information on a DVD-R disc on which nothing has been recorded.

As described above, according to the embodiment, as the second reflective layer 16 is provided on the recording surface A-side of the optical plotting layer 17, an image plotted on the optical plotting layer 17 can gain enough contrast. Accordingly, it is possible to plot a clear image viewed from the label surface B-side. Further, the optical plotting layer 17 can change by heat adequately by heating the second reflective layer 16 with the CD laser beam 28 and transferring the heat to the optical plotting layer 17 (a heat transfer between solid substances). Also, it is possible to plot at desired positions on the optical plotting layer 17 accurately by providing the plotting guide track 24. Therefore, it is possible to plot without using the recording/reproducing guide track 21 provided on the information recording layer 12, and to configure to separate the optical plotting layer 17 from the information recording layer 12 properly.

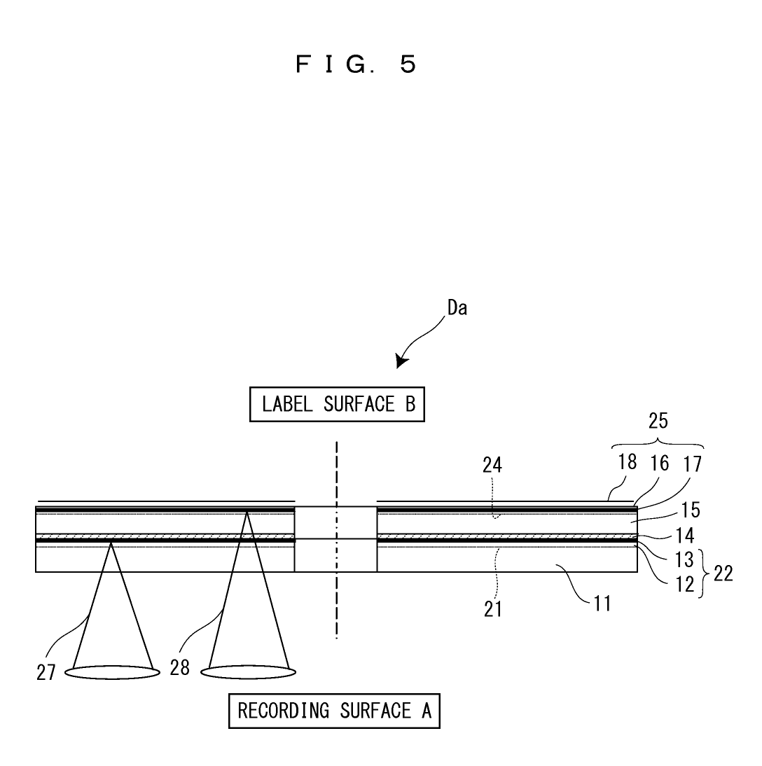

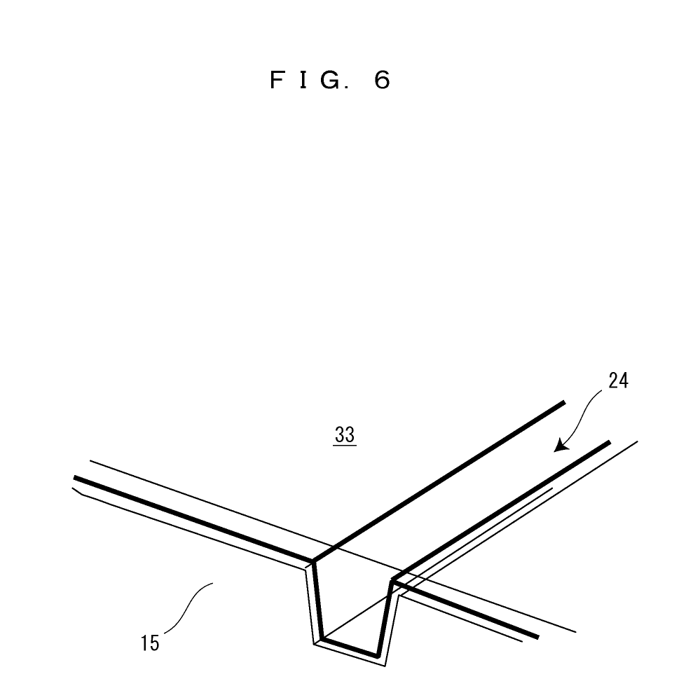

As an modified example of the first embodiment, the second reflective layer 16 may be formed between the optical plotting layer 17 and the protective layer 18 (see FIG. 5). In this case, it is preferable that the second reflective layer 16 be configured to be able to transmit visible light. Accordingly, in a case that the plotting guide track 24 is used for tracking and focusing for plotting, sufficient reflective light can be obtained, the heat sensitive material of the optical plotting layer 17 can be heated directly and the plotting laser power can be smaller. Further, visibility of a plotting result is not impaired. Still further, the plotting guide track 24 may be formed as a continuous groove as same as the recording/reproducing guide track (see FIG. 6). The optical plotting layer 17 can be plotted while the plotting guide track 24 is tracked. Therefore, it is possible to plot without using the recording/reproducing guide track 21 provided on the information recording layer 12, and to configure to separate the optical plotting layer 17 from the information recording layer 12 sufficiently.

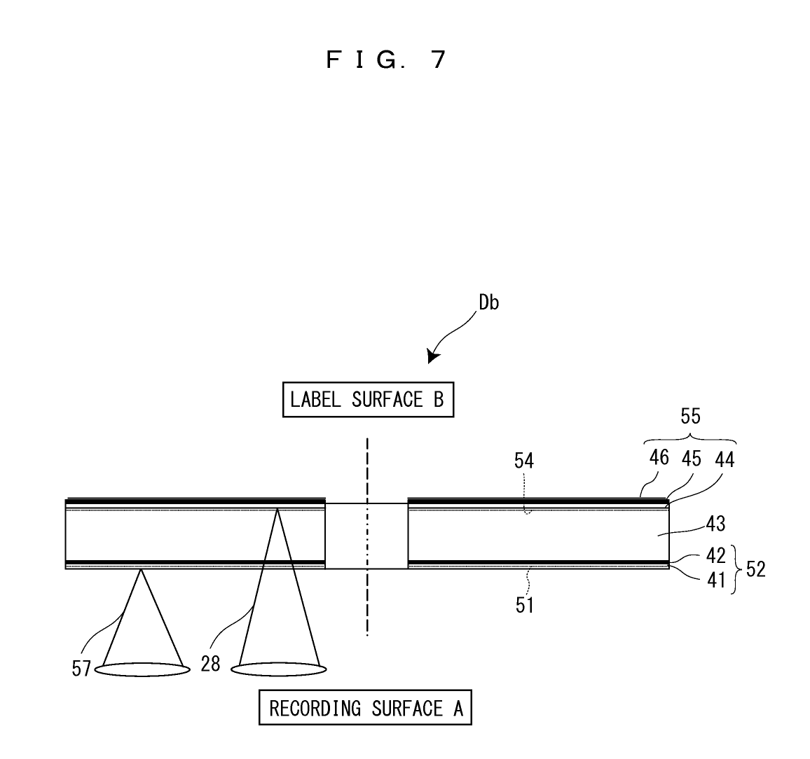

Referring to FIG. 7, the second embodiment will be explained, in which an optical disc Db is configured of a Blu-ray Disc and differences from the first embodiment will be mainly described. The optical disc Db has, from the recording surface A-side in turn, an information recording layer 41, the first reflective layer 42, a substrate 43, the second reflective layer 44, an optical plotting layer 45 and a protective layer 46 in layers (a protective layer at the recording surface A-side is omitted). A recording/reproducing guide track 51 is formed on the information recording layer 41, and the first reflective layer 42 and the information recording layer 41 make up of a Blue-ray Disc layer 52 used for recording/reproducing with a Blu-ray Disc semi-conductor laser. Also, as same as the first embodiment, a plotting guide track 54 is formed on the optical plotting layer 45, and the second reflective layer 44, the optical plotting layer 45 and the protective layer 46 make up of an image forming layer 55 used for plotting with a CD semi-conductor laser.

Also in this case, the first reflective layer 42 is made up of a wavelength selectivity transmitting reflective film. The first reflective layer 42 reflects a Blu-ray Disc laser beam 57 (405 nm) transmitted through the information recording layer 41 and transmits the CD laser beam 28 (780 nm). The optical plotting layer 45 (the second reflective layer 44) is plotted with the CD laser beam 28 based on plotting data while the CD laser beam 28 tracks on the plotting guide track 54.

Thus, even if the optical disc Db is a Blu-ray Disc, it is possible to plot a clear image by the second reflective layer 44 viewed from the label surface B-side, and to configure to sufficiently separate the optical plotting layer 45 from the information recording layer 41.

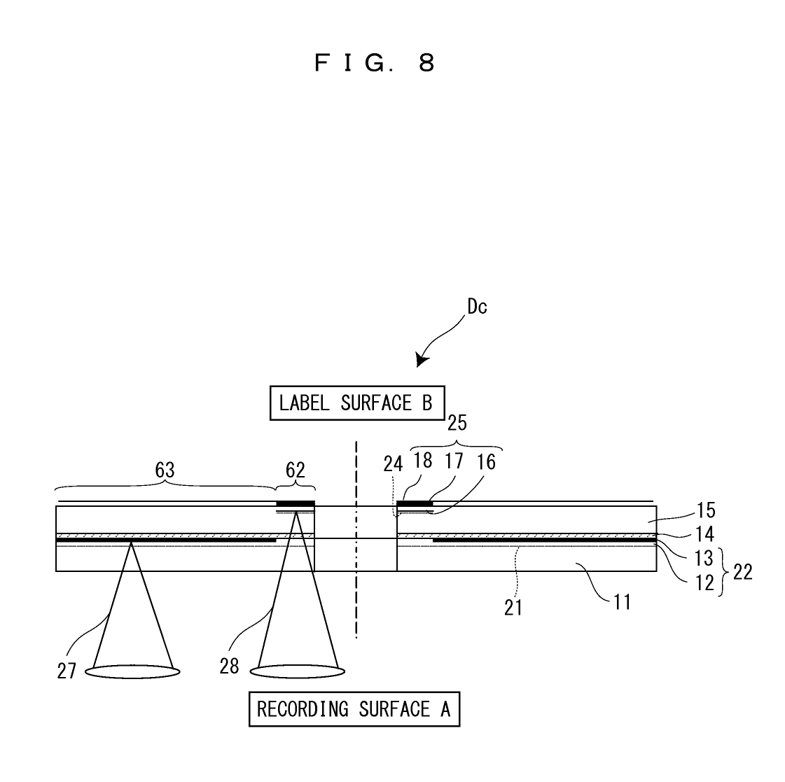

Referring to FIG. 8, the third embodiment of an optical disc Dc made up of a DVD-R will be explained, in which differences from the first embodiment will be mainly described. In this embodiment, the image forming layer 25 is formed in an area other than a data area 61, for example, a clamp area 62. In other words, the DVD layer 22 having the information recording layer 12 and the first reflective layer 13 is formed in the data area 61 of the optical disc Dc, and the image forming layer 25 having the second reflective layer 16 and the optical plotting layer 17 (the protective layer 16) is formed in the clamp area 62.

As same as the first embodiment, the recording/reproducing guide track 21 is formed in the data area 61 of the information recording layer 12 and the plotting guide track 24 is formed in the clamp area 62 of the optical plotting layer 17. The optical plotting layer 17 (the second reflective layer 16) is plotted with the CD laser beam 28 based on plotting data while the CD laser beam 28 tracks on the plotting guide track 24. Note that the image forming layer may be formed at the same laminated position of the above DVD layer.

Thus, as the recording/reproducing DVD layer 22 and the image forming layer 25 having the optical plotting layer 17 are not stacked, it is possible to plot on the optical plotting layer 17 without giving any influence to the information recording layer 12, the first reflective layer 13 and the like. The structure of the above third embodiment can be applied to a Blu-ray Disc.

1. An optical disc comprising:
an optical plotting layer that is formed at a label surface side and on which an image is formed by heat change with a CD laser beam emitted from a recording surface side;
a protective layer that is formed at the label surface side of the optical plotting layer, protects the optical plotting layer, and through which the image can be viewed from the label surface side;
a reflective layer that is formed at the recording surface side of the optical plotting layer and reflects the CD laser beam;
a substrate that supports the reflective layer, the protective layer and the optical plotting layer;
a bonded substrate laminated at the recording surface side of the substrate; and
an information recording layer formed at a bonded side of the bonded substrate and on which information is recorded and/or reproduced with a DVD laser beam;
wherein the information recording layer has a wavelength selectivity transmitting reflective film that reflects the DVD laser beam and transmits the CD laser beam.

2-3. (canceled)

4. The optical disc according to claim 1, further comprising an information recording layer formed at the recording surface side of the substrate, wherein the information recording layer has a wavelength selectivity transmitting reflective film.

5. The optical disc according to claim 1, wherein the reflective layer, the protective layer and the optical plotting layer are formed in an area other than a data area.

6. The optical disc according to claim 1, wherein the optical plotting layer is made up of heat sensitive material mixed with a metallic particle.

7. The optical disc according to claim 1, wherein the protective layer serves as a printing layer capable of being printed by a printing apparatus.

8. The optical disc according to claim 1, wherein the protective layer serves as a printing layer capable of being printed by a printing apparatus, and color of non-plotted optical plotting layer is tinged with white.

9. An optical disc apparatus that is introduced with the optical disc as set forth in claim 1, emits the DVD laser beam on the information recording layer to record and/or reproduce information, and emits the CD laser beam on the optical plotting layer to plot the image.

10-11. (canceled)
